(19) United States
(12) Patent Application Publication
(10) Pub. No.: US 2015/0321547 A1
(43) Pub. Date: Nov. 12, 2015

(54) VEHICLE WITH A FRONT AIR DUCT AND METHOD OF CONTROLLING AN AIR FLOW, IN PARTICULAR COOLING AIR FLOW

(71) Applicant: Audi AG, Ingolstadt (DE)

(72) Inventor: Richard PICKL, Denkendorf (DE)

(73) Assignee: Audi AG, Ingolstadt (DE)

(21) Appl. No.: 14/704,695

(22) Filed: May 5, 2015

(30) Foreign Application Priority Data
May 7, 2014 (DE) 10 2014 006 597.9

(51) Int. Cl. B60K 11/08; B62D 37/02; B60K 11/06; B62D 35/00

(52) U.S. Cl. CPC B60K 11/08; B62D 35/005; B62D 37/02; B60K 11/06

(57) ABSTRACT

A vehicle, in particular a motor vehicle, includes a vehicle front having a front end provided with an air inlet in communication with an air duct. A front hood having an air outlet is in communication with the air duct and includes an adjustment member configured for movement to a closing position in which the air outlet is closed.

### CROSS-REFERENCES TO RELATED APPLICATIONS

This application claims the priority of German Patent Application, Serial No. 10 2014 006 587.9, filed May 7, 2014, pursuant to 35 U.S.C. 119(a)-(d), the disclosure of which is incorporated herein by reference in its entirety as if fully set forth herein.

### BACKGROUND OF THE INVENTION

The present invention relates to a vehicle with a front air duct, and to a method of controlling an air flow, in particular cooling-air flow.

The following discussion of related art is provided to assist the reader in understanding the advantages of the invention, and is not to be construed as an admission that this related art is prior art to this invention.

In sports cars for example that have a powerful engine, the engine cooling efficiency can be enhanced through the provision of a cooling-air duct which extends as separate air duct from air inlets arranged at the front end, especially radiator grille, upwards in the direction of the front hood to feed into one or more air outlets. Disposed in the cooling-air duct is a radiator which is typically configured as a module and may include in addition to the actual radiator also an air conditioner and/or fan module. Cooling air incoming from the vehicle front flows into the cooling-air duct via the radiator and via the air outlets into the environment.

The air outlets are normally raised in relation to the front hood surface and thus oftentimes adversely affect the drag coefficient of a motor vehicle because the air outlets cause flow turbulences and swirls. In addition, there is the risk of ingress of pollutants, e.g. foliage or the like, into the air duct to thereby cause contamination. Also snow may enter the air duct via the air outlets and cause freezing of the radiator or cooling duct. All these factors adversely affect cooling efficiency of the radiator. Moreover, the presence of edges and protrusions formed by the air outlets on the front hood poses also a risk in the event of an impact upon the front hood, especially when, for example, a collision with a pedestrian is involved.

It would therefore be desirable and advantageous to address these problems and to obviate other prior art shortcomings.

### SUMMARY OF THE INVENTION

According to one aspect of the present invention, a vehicle, in particular a motor vehicle, includes a vehicle front having a front end provided with an air inlet in communication with an air duct, and a front hood having an air outlet in communication with the air duct, said front hood having an adjustment member configured for movement to a closing position in which the air outlet is closed.

As a result of the approach taken by the present invention, the air duct is protected in a simple manner from any ingress of pollutants, snow or the like so that operation of any functional components arranged in the air duct, such as e.g. radiator, is reliably maintained and not adversely affected. As the air outlet is closeable, the surface of the front hood has no edges or projections so as to maintain continuity of the surface and a pleasing look.

According to another advantageous feature of the present invention, the air duct can be a cooling-air duct extending underneath the front hood, with a radiator being disposed in the cooling-air duct. The radiator may be configured as a multipart radiator module comprised of a radiator, air conditioner and/or fan module. The radiator may be an engine radiator of a vehicle drive unit (internal combustion engine and/or electric machine) covered by the front hood. As the air outlet is closeable, there are no edges or protrusions so that the presence of the air outlet does not interfere with a planar and smooth surface of the front hood in the closing position of the adjustment member. As a result, there is less danger in the event of an impact, for example in the event of a collision with a pedestrian.

According to another advantageous feature of the present invention, the air inlet can be sized to extend to an area of a radiator grille or to extend to an area of the front end in close vicinity of the radiator grille, with the air duct being configured to extend from the air inlet in a vertical axis direction upwards towards the front hood.

Currently preferred is the provision of the air duct as a separate passageway. Optionally, the air duct may also be a component of an air duct system.

According to another advantageous feature of the present invention, an actuating device can be operably connected to the adjustment member to move the adjustment member to a defined position. The actuating device may be configured as actuator that is simple in structure and easy to operate, e.g. an electrically, hydraulically, or pneumatically operated actuator. Advantageously the actuating device can be activated or operated by a control device. The movement of the adjustment member can be realized in response to a detected parameter and/or predefined parameter and/or determined parameter, which may involve e.g. an environmental parameter and/or operating parameter and/or a driving parameter. Data can be ascertained for example by a sensor of the vehicle. The control device may, of course, also include or be operably connected to a processing device in which the detected and/or transmitted data from assist systems and/or detectors, such as, e.g., sensors, are analyzed and processed to generate control commands, when respective threshold values and/or criteria are reached.

According to another advantageous feature of the present invention, the air outlet can be arranged in a sub-atmospheric pressure zone of the front hood as a result of sub-atmospheric pressure caused during travel of the vehicle. This has a positive effect on the drag coefficient. Advantageously, the air outlet can be arranged with respect to a vehicle longitudinal direction in a front half of the front hood in facing relation to a leading hood edge of the front hood. The arrangement of the air outlet in the sub-atmospheric pressure zone promotes a beneficial air flow from the air inlet, without encountering excessive turbulences and swirls. Again, as described above, this has a positive effect on the drag coefficient.

According to another advantageous feature of the present invention, the adjustment member can be a component of the front hood. Advantageously, the adjustment member is an integral component of the front hood. In this way, the front hood assumes a dual function by forming not only the air outlet but also the adjustment member. Currently preferred is a configuration of the adjustment member in the form of a plate-shaped surface element. Such a surface element can easily be integrated into the front hood. Although the presence of several movable adjustment members, e.g. in the form of plate-shaped surface elements, may, of course, also be conceivable, the use of a single adjustment member is currently preferred because of the reduction in the number of structural components. A single, plate-shaped surface element is especially easy to integrate into the front hood which already has a flat configuration. It will still be understood by persons skilled in the art that the present invention is not limited to the presence of a single adjustment member, even though this may currently be a preferred embodiment.

The adjustment member may be configured in any shape or form. Advantageously, the adjustment member can have a rectangular outer contour. In this way, the realization of an adjustment member in the form of a swingable flap-type configuration and simple attachment thereof to the front hood are possible.

The front hood may or may not be swingably arranged onto the vehicle and can cover as engine hood a drive unit (internal combustion engine and/or electric machine) of the vehicle.

According to another advantageous feature of the present invention, the adjustment member can be configured and/or arranged on the front hood such as to transition flush with a surface of an adjacent region of the front hood, when the adjustment member is moved into the closing position in which the air outlet is closed. As a result, as described above, such a configuration is beneficial to meet demands in the event of a collision with a pedestrian. Advantageously, the adjustment member can transition flush with the surface of the adjacent region of the front hood without seam and edge to form a continuously planar and smooth surface of the front hood in the area of the adjustment member and adjacent front hood zones. In this way, the presence of impacting edges or sudden changes in the contour are prevented that would otherwise pose a hazard in the event of an impact.

According to another advantageous feature of the present invention, the adjustment member can have at least one region which in relation to a vertical axis direction is positioned lower in relation to the closing position and/or a surface of the front hood, when the adjustment member assumes a position in which the air outlet is open. In this way, aerodynamics is still enhanced and a beneficial drag coefficient is established, even though the air outlet is open. Although currently less desired for the foregoing reasons, it is, of course, also conceivable and to be considered within the scope of the invention to move the air outlet upwards in a vertical axis direction.

According to another advantageous feature of the present invention, the front hood can be configured elastically in an area of attachment and/or articulation of the adjustment member so that the adjustment member is swingably mounted to the front hood, e.g. in the form of a swingable flap, as a result of an elastic material property in the area of the front hood. In other words, the elastic material property of the front hood in the attachment and/or articulation zone of the adjustment member to the front hood is exploited to realize the swingability of the adjustment member in the form of a swingable flap that has been cut out of the front hood and integrated in the front hood. The expression “elastic material property” is used in the description to mean that the front hood can be shifted or pivoted in any desired position in this pivot zone that forms the attachment and/or articulation zone of the adjustment member, in the absence of any lasting plastic or permanent deformation. For that purpose, the front hood may be made, at least in part, from a plastic material and/or steel or sheet metal material that has such elasticity characteristics.

According to another advantageous feature of the present invention, the adjustment member can be hinged, like a hinge joint, to the front hood for pivoting about a pivot axis. The articulation can hereby be realized by integrating the pivot axis in the front hood invisibly from the visible side of the front hood so that the overall outer optical look of the front hood is not adversely affected. Advantageously, the pivot axis may hereby be configured, in particular in combination with a front hood made of plastic at least in the attachment zone of the adjustment member, in the form of a film hinge, or the pivot axis may be configured for example as a material weakening, especially on the underside of the front hood that faces away from the visible side. Advantageously, the pivot axis can extend in vehicle transverse direction.

According to another advantageous feature of the present invention, the adjustment member can be configured to extend rearwards towards a windshield, as viewed in vehicle longitudinal direction, and adjoin the air outlet. This kind of configuration can easily be integrated in a front hood to satisfy current trends in design. Advantageously, the air outlet can be configured to form a rearwardly open air outlet port, as viewed in vehicle longitudinal direction, when the adjustment member assumes the open position in which the air outlet is open. Outflow conditions are as a result most beneficial in the absence of any turbulences and swirls that can adversely affect the drag coefficient. Advantageously, the air outlet port can be configured to conduct an air flow, exiting the air outlet port, to flow along the adjustment member in a direction towards the windshield of the vehicle. The adjustment member may hereby have a ramp-shaped configuration in the open position and extend rearwards to the windshield.

According to another advantageous feature of the present invention, the air outlet port can be configured to form an air outlet slot which extends substantially in a vehicle transverse direction, when the adjustment member assumes the open position in which the air outlet is open. Advantageously, the air outlet slot can be arranged in midsection or in the center of the front hood, as viewed in the vehicle transverse direction. In this way, a symmetric look is maintained and manufacture is simplified.

According to another aspect of the present invention, a method of controlling an air flow between an air inlet on a front end of a front hood of a vehicle and an air outlet in the front hood, includes moving an adjustment member by an actuating device in response to a detected and/or determined and/or predefined parameter from an open position in which the air outlet is cleared to a closed position in which the air outlet is closed.

The advantages described above with respect to the vehicle are also achieved by a method according to the present invention and thus are not repeated here for the sake of simplicity.

According to another advantageous feature of the present invention, operation of the actuating device can be controlled by a control device.

According to another advantageous feature of the present invention, the adjustment member can be moved to the closed position in the presence of defined traveling and/or operating conditions, such as start-up operation or vehicle standstill, and/or a defined climatic conditions, such as snowfall or temperature below freezing, and/or actual or imminent collision with a pedestrian, as detected by a sensor at a front end of the front hood.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a front and side perspective illustration of a forward structure of a vehicle according to the present invention;

FIG. 2 is a schematic cross section of the forward structure of FIG. 1 with lowered adjustment member to thereby open an air outlet;

FIG. 3 is a schematic cross section of the forward structure, depicting the adjustment member in a closing position to thereby close the air outlet; and

FIG. 4 is a schematic illustration of the forward structure, depicting flow conditions in the area of the air duct and open air outlet.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

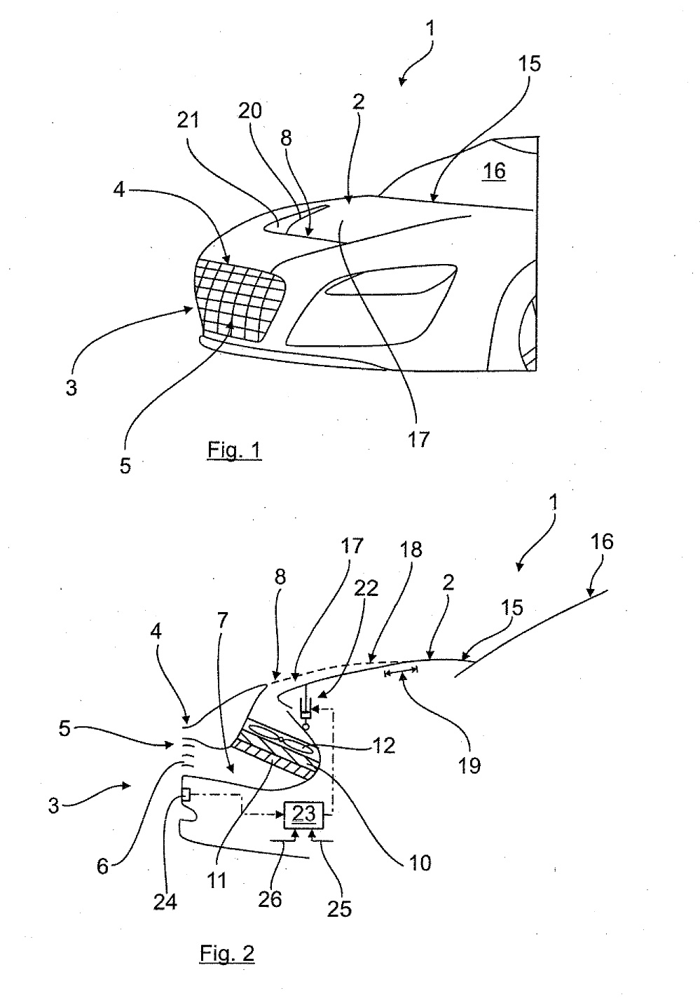

Turning now to the drawing, and in particular to FIG. 1, there is shown a front and side perspective illustration of a vehicle front of a vehicle according to the present invention, generally designated by reference numeral 1. The vehicle 1, for example a sports car, has a front hood 2 which covers a not shown drive unit, e.g. an internal combustion engine, an electric machine, or a hybrid drive, mounted in a forward structure of the vehicle. A radiator grille 5 is arranged adjacent to a front hood edge 4 of the front hood 2 in the area of the front end 3.

As is readily apparent from FIG. 2, which shows a cross section of the forward structure, an air inlet 6 is formed by way of example in the area of the radiator grille 5 which feeds into an air duct 7 formed as cooling-air duct. The air duct 7 extends from the air inlet 6 substantially in a vertical axis direction upwards towards the front hood 2 and feeds into an air outlet 8 which may be configured as an air outlet slot. It is, of course, also conceivable to arrange the air inlet 6 at any other suitable location of the forwards structure, for example laterally next and/or above and/or below the radiator grille 5.

As is shown in particular in FIG. 2, the air outlet 8 forms, as viewed in vehicle longitudinal direction, essentially an air outlet port which is open to the rear to enable an air flow of e.g. cooling air to flow out, as indicated in FIG. 4 by arrow 9.

Arranged in the air duct 7 in the region underneath the air outlet 8 is an engine radiator or radiator 10 which is associated to a not shown drive unit. In the non-limiting example shown here, the radiator 10 is configured as a multipart radiator module which includes in addition to the actual radiator unit optionally also an air conditioner 11 and/or a fan module 12.

Ambient air, indicated in FIG. 4 by arrow 13, entering via the air inlet 6 on the side of the radiator grille 5, flows along the air duct 7 through the radiator 10 and is released as cooling air, as indicated by arrow 9, via the air outlet 8 into the environment, thereby realizing an efficient, optimized cooling of the drive unit.

As can be further seen from FIG. 1, the air outlet 8, formed here by way of example as an air outlet slot, is arranged on the front hood 2 approximately in midsection and centrally with respect to the vehicle transverse direction and, as illustrated in FIG. 4 by dash-dot line, in a sub-atmospheric pressure zone 14 of the front hood 2 in which zone a pressure below atmospheric prevails during travel mode. This ensures during travel mode in the region of the air outlet 8 the absence of air swirls and turbulences that could adversely affect the drag coefficient. Rather, a flow of cooling air 9 is established in a desired manner along the front hood 2 in a direction to the windshield 16 which is adjacent to a rear edge 15 of the front hood 2.

To prevent the presence of edges and protrusions on the front hood 2 in the region of the air outlet 8 and to be able to prevent ingress of pollutants, snow, etc. via the air outlet 8 into the air duct 7, a movable adjustment member 7 is integrated in the front hood 2. The movable adjustment member 17, thus forming an integral component of the front hood 2, is shown here by way of example, in the form of a single, plate-shaped surface element having a substantially rectangular outer contour, as best seen in FIG. 1. The movable adjustment member 17 is shown in FIG. 2 with respect to a vertical axis direction in a position in which the air outlet 8 is open or cleared in relation to the front hood surface 18, shown by way of dashed line. Hence, in the open position of the air outlet 8, the flow of cooling air 9 is able to exit through the air outlet 8 into the environment.

The adjustment member 17 can be configured in the form of a swingable flap which is swingable about a pivot axis integrated in the front hood 2. Such a pivot axis should be invisible from the visible side of the front hood 2. This may be realized for example by providing a material weakening on the front hood underside which faces away from the visible side, or by configuring the pivot axis in the form of a film hinge. Currently preferred is, however, an embodiment in which the adjustment member 17 is movable like a swingable flap and integrated in the front hood 2 in a manner shown schematically in FIGS. 1 to 3. In this embodiment, elastic material properties of the front hood 2 are exploited in an attachment or articulation zone 19 of the adjustment member 17 on the front hood 2. In other words, the front hood 2 is elastic in the pivot zone which is formed in the attachment or articulation zone 19 of the front hood 2 and in which the adjustment member 17 can swing such that the adjustment member 17 can be pivoted in this zone 19 in any desired position, in the absence of a plastic and lasting deformation. For this purpose, the front hood 2 may be made, at least in some areas, from plastic material and/or from steel or sheet metal material having such elasticity characteristics.

The attachment or articulation zone 19 extends substantially in vehicle transverse direction and is distanced from the air outlet 8, as viewed in vehicle longitudinal direction, rearwards towards the windshield 16 so that, in the embodiment shown here, the adjustment member 17 is sized, as viewed in vehicle longitudinal direction, to extend rearwards towards the windshield 16 and adjoins the air outlet 8.

The adjustment member 17 has opposite lateral marginal areas 20 (of which one is only shown in FIG. 1) adjacent to lateral front hood wall regions 21, respectively, when the adjustment member 17 is lowered to assume the open position. The lateral marginal areas 20 directly or snugly abut hereby the lateral front hood wall regions 21 which can be formed, as viewed in vertical axis direction of the vehicle are vertical, for example by providing a respective angle of bend.

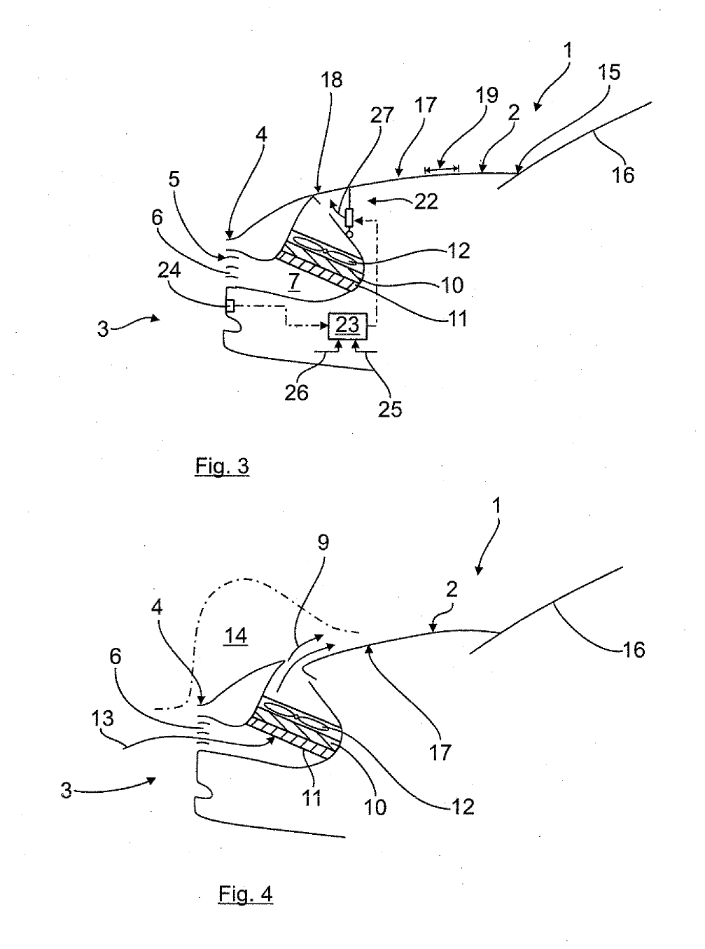

As further illustrated in FIG. 2 and shown only schematically and by way of example, the adjustment member 17 is operably connected to an actuating device 22, e.g. an actuator or the like, which can be activated by a control device 23. The control device 23 may be operably connected for example to a sensor 24 arranged on the front end 3 of the vehicle forward structure and transmitting a signal to the control device 23 in response, for example, to an imminent or actual collision of the vehicle 1 with a pedestrian. The control device 23 thus activates the actuating device 22 which, in turn, raises the adjustment member 17 from the open position, shown in FIG. 2, to the closed position, shown in FIG. 3, as indicated by arrow 27. As a result, the air outlet 8 on the front hood 2 is closed.

As further shown in FIGS. 2 and 3, the control device 23 may, of course, also be responsive for closing of the air outlet 8 in dependence on any appropriate and predefined parameters, e.g. environmental and/or operating parameters and/or travel parameters. This is indicated by signal arrows 25 and 26. For example, such parameters may relate to whether the vehicle is in a startup phase or at standstill, or the presence of certain climatic conditions, such as, e.g., rain, snowfall, or temperature below freezing. In particular, when snowfall is involved, ingress of snow into the air outlet 8 should be avoided to prevent freezing of the radiator 10 or fan 12.

As further shown schematically in FIG. 3, the adjustment member 17 is arranged in closed position on the front hood 2 such that the adjustment member 17 transitions flush with the adjacent front hood regions, so that the front hood 2 has no break in the continuity of the front hood surface. Thus, a continuous planar and smooth front hood surface is established in the area of the adjustment member 17 and the adjacent front hood regions, in the absence of any edges. This is beneficial in particular for protection of pedestrians.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A vehicle, comprising:
a vehicle front having a front end provided with an air inlet in communication with an air duct; and
a front hood having an air outlet in communication with the air duct, said front hood having an adjustment member configured for movement to a closing position in which the air outlet is closed.

2. The vehicle of claim 1, wherein the vehicle is a motor vehicle.

3. The vehicle of claim 1, wherein the air duct is a cooling-air duct extending underneath the front hood, further comprising a radiator disposed in the cooling-air duct.

4. The vehicle of claim 1, wherein the radiator is an engine radiator of a drive unit of the vehicle.

5. The vehicle of claim 1, further comprising a radiator grille, said air inlet being sized to extend to the area of the radiator grille or to extend to an area of the front end in close vicinity of the radiator grille, said air duct being configured to extend from the air inlet in a vertical axis direction upwards towards the front hood.

6. The vehicle of claim 1, further comprising an actuating device operably connected to the adjustment member to move the adjustment member to a defined position in at least one of a plurality of ways, a first way in which the actuating device is controlled by a control device, a second way in which the actuating device moves the adjustment member in response to a detected parameter, a third way in which the actuating device moves the adjustment member in response to a predefined parameter, a fourth way in which the actuating device moves the adjustment member in response to a determined parameter.

7. The vehicle of claim 6, further comprising a sensor configured to detect the parameter.

8. The vehicle of claim 6, wherein the parameter is an environmental parameter and/or an operating parameter and/or a driving parameter.

9. The vehicle of claim 1, wherein the air outlet is arranged in a sub-atmospheric pressure zone of the front hood as a result of sub-atmospheric pressure caused during travel of the vehicle.

10. The vehicle of claim 9, wherein the front hood has a leading hood edge, said air outlet being arranged with respect to a vehicle longitudinal direction in a front half of the front hood in facing relation to the leading hood edge.

11. The vehicle of claim 1, wherein the adjustment member is a component of the front hood.

12. The vehicle of claim 1, wherein the adjustment member is an integral component of the front hood.

13. The vehicle of claim 1, wherein the adjustment member is formed by a plate-shaped surface element.

14. The vehicle of claim 13, wherein the plate-shaped surface element has a rectangular outer contour.

15. The vehicle of claim 1, wherein the adjustment member is configured and/or arranged on the front hood such as to transition flush with a surface of an adjacent region of the front hood, when the adjustment member is moved into a position in which the air outlet is closed.

16. The vehicle of claim 15, wherein the adjustment member transitions flush with the surface of the adjacent region of the front hood without seam and edge to form a continuously planar and smooth surface of the front hood.

17. The vehicle of claim 1, wherein the adjustment member has at least one region which in relation to a vertical axis direction is positioned lower in relation to the closing position and/or a surface of the front hood, when the adjustment member assumes a position in which the air outlet is open.

18. The vehicle of claim 1, wherein the front hood is configured elastically in an area of attachment of the adjustment member so that the adjustment member is swingably mounted to the front hood as a result of an elastic material property in the area of the front hood.

19. The vehicle of claim 18, wherein the adjustment member is configured as a swingable flap.

20. The vehicle of claim 1, wherein the adjustment member is hinged to the front hood for pivoting about a pivot axis integrated invisibly from a visible side of the front hood.

21. The vehicle of claim 20, wherein the pivot axis extend in vehicle transverse direction.

22. The vehicle of claim 1, wherein the adjustment member is configured to extend rearwards towards a windshield, as viewed in vehicle longitudinal direction, and adjoins the air outlet.

23. The vehicle of claim 1, wherein the air outlet is configured to form a rearwardly open air outlet port, when the adjustment member assumes an open position in which the air outlet is open.

24. The vehicle of claim 23, wherein the air outlet port is configured to conduct an air flow exiting the air outlet port to flow along the adjustment member in a direction towards a windshield of the vehicle.

25. The vehicle of claim 24, wherein the adjustment member has a ramp-shaped configuration in the open position and extends rearwards to the windshield.

26. The vehicle of claim 1, wherein the air outlet port is configured to form an air outlet slot which extends substantially in a vehicle transverse direction, when the adjustment member assumes an open position in which the air outlet is open.

27. The vehicle of claim 26, wherein the air outlet slot is arranged in midsection of the front hood, as viewed in the vehicle transverse direction.

28. A method of controlling an air flow between an air inlet on a front end of a front hood of a vehicle and an air outlet in the front hood, said method comprising moving an adjustment member by an actuating device in response to a detected and/or determined and/or predefined parameter from an open position in which the air outlet is cleared to a closed position in which the air outlet is closed.

29. The method of claim 28, further comprising controlling operation of the actuating device by a control device.

30. The method of claim 28, wherein the adjustment member is moved to the closed position in the presence of defined traveling and/or operating conditions, such as start-up operation or vehicle standstill, and/or a defined climatic conditions, such as snowfall or temperature below freezing, and/or collision with a pedestrian, as detected by a sensor at a front end of the front hood.
